(19) United States
(12) Patent Application Publication
(10) Pub. No.: US 2006/0077912 A1
(43) Pub. Date: Apr. 13, 2006

(54) Telecommunication system with non-(re)allocatable and (re)allocatable timeslots

(75) Inventor: Jiang Jon Cheng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/526,977

(22) PCT Filed: Sep. 18, 2003
(86) PCT No.: PCT/IB03/04096

§ 371 Date: Mar. 29, 2005

(30) Foreign Application Priority Data
Oct. 1, 2002 (EP) 02079040.8

(51) Int. Cl. H04L 12/16

(52) U.S. Cl. 370/265; 370/348

(57) ABSTRACT

Telecommunication systems for providing telecommunication services via communication channels (50) with time-frame structures having at least two flexible timeslots which are (re)allocatable to an uplink or a downlink can be made more practical by introducing at least one fixed (non-(re)allocatable) uplink timeslot, at least one fixed (non-(re)allocatable) downlink timeslot, and by introducing according to a basic idea in said flexible timeslots a first number of timeslots with an uplink priority and a second number of timeslots with a downlink priority. Said at least one fixed uplink timeslot can be one fixed uplink timeslot, said at least one fixed downlink timeslot can be one fixed downlink timeslot, with said first and second number of timeslots coinciding, and with one kind of priority increasing and with the other kind of priority decreasing per timeslot. Alternatively, rules and/or interference detection results are used for defining (locations and/or priorities for) said first and second number of timeslots.

The invention relates to a telecommunication system comprising at least a first station and a second station for providing a telecommunication service via at least one communication channel with a time-frame structure with at least one group of timeslots, in which group at least two timeslots are flexible timeslots each being (re)allocatable to an uplink or a downlink.

The invention also relates to a station for use in a telecommunication system, and to a method for use in a telecommunication system, and to a processor program product to be run via a processor in a station in a telecommunication system.

Such a telecommunication system for example corresponds with a time division duplex (TDD) cellular telephone system or with a Time Division Code Division Multiple Access (TD-CDMA) system, with said first station for example being a base station or a node etc. and with said second station for example being a mobile station etc., without excluding both stations being base stations or nodes or mobile stations etc. A flexible timeslot is either allocated to an uplink or a downlink respectively and can then be re-allocated to a downlink or an uplink respectively, or has not yet been allocated to whatever link and can then be allocated to an uplink or a downlink.

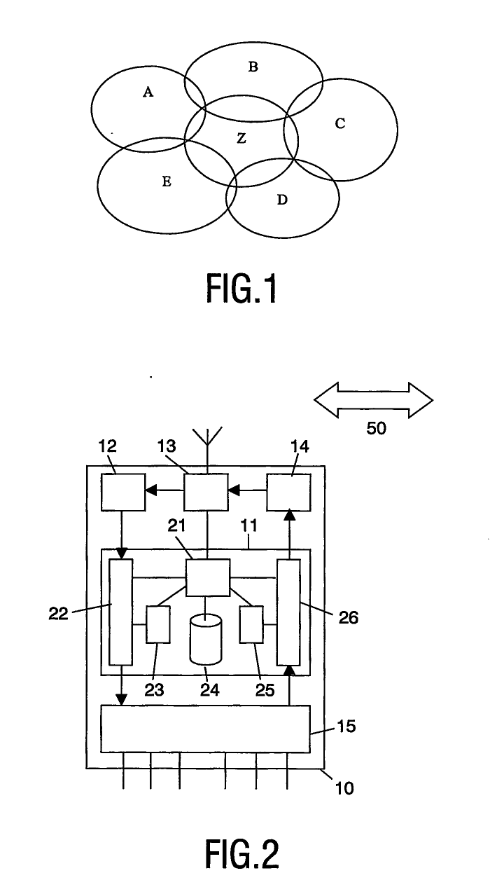

A prior art telecommunication system is known from EP 1 122 895 A1, which discloses in its paragraph 0001 a time division duplex cellular telephone system (a telecommunication system) comprising as shown in its FIG. 1 at least a Base Transceiver Station (for example a first station) and a Mobile Station (for example a second station) for providing as disclosed in its paragraph 0015 a telecommunication service via at least one communication channel with a time-frame structure with a plurality of timeslots (at least one group of timeslots) having reassignable timeslots as disclosed in paragraph 0015 (flexible timeslots which can be allocated to an uplink or a downlink).

The prior art telecommunication system solves the problem of maximizing system capacity while keeping interference to a minimum in a telecommunication system where asymmetrical data rates between uplinks and downlinks may exist. However, for deciding which timeslot is to be assigned to which link, the prior art telecommunication system requires many complex interference detections (calculations), which is not practical. Especially where asymmetrical data rates between uplinks and downlinks may exist, not just base-station-mobile-station-interference needs to be detected, but also base-station-base-station-interference and mobile-station-mobile-station-interference need to be detected.

The known telecommunication system is disadvantageous, inter alia, due to not being practical.

It is an object of the invention, inter alia, of providing a telecommunication system as defined in the preamble which is more practical.

It is a further object of the invention, inter alia, of providing a station as defined in the preamble which is more practical.

It is a yet further object of the invention, inter alia, of providing a method as defined in the preamble which is more practical.

It is also an object of the invention, inter alia, of providing a processor program product as defined in the preamble which is more practical.

The telecommunication system according to the invention comprises at least a first station and a second station for providing a telecommunication service via at least one communication channel with a time-frame structure with at least one group of timeslots, in which group at least two timeslots are flexible timeslots each being (re)allocatable to an uplink or a downlink, wherein in said group at least one timeslot is a fixed uplink timeslot, at least one timeslot is a fixed downlink timeslot, and said at least two flexible timeslots comprise a first number of timeslots having a priority of an uplink kind and a second number of timeslots having a priority of a downlink kind.

By defining in said group at least one timeslot to be a fixed uplink timeslot, which can not be re-allocated to a downlink, and by defining at least one timeslot to be a fixed downlink timeslot, which can not be re-allocated to an uplink, with said at least two flexible timeslots being (re)allocatable timeslots comprising a first number of timeslots having uplink priorities and a second number of timeslots having downlink priorities, a more practical telecommunication system has been created which requires less interference detections (calculations) due to being guided by said uplink and downlink priorities while combining fixed and flexible timeslots.

A first embodiment of the telecommunication system according to the invention is defined by claim 2.

By defining per (sub)frame one fixed uplink timeslot, one fixed downlink timeslot, with all other timeslots in said (sub)frame being (re)allocatable to an uplink or a downlink, a first embodiment has been created which is low complex, due to said first number of (subsequent) timeslots and said second number of (subsequent) timeslots coinciding. Said one kind of priority increasing and said other kind of priority decreasing per timeslot keep interference at a low level due to keeping maximum distance between uplink and downlink timeslots. After a timeslot has been selected (based upon uplink or downlink priorities) for being (re)allocated to an uplink or a downlink, generally one or more interference detections will be required for checking interference constraints, possibly per service.

A second embodiment of the telecommunication system according to the invention is defined by claim 3.

By using rules which take into account at least one adjacent cell for defining per (sub)frame that said first number of (subsequent) timeslots is situated at one side of said group of timeslots and that said second number of (subsequent) timeslots is situated at the other side of said group of timeslots, with both numbers of (subsequent) timeslots partly overlapping or not, thereby possibly further defining priorities, a second embodiment has been created which, compared to said first embodiment, is a little bit more complex, but still of low complexity, and which keeps interference at a minimum while now taking into account neighboring cells. After a timeslot has been selected (based upon uplink or downlink priorities) for being (re)allocated to an uplink or a downlink, generally one or more interference detections will be required for checking interference constraints, possibly per service.

A third embodiment of the telecommunication system according to the invention is defined by claim 4.

By using interference detection results (possibly per service) for defining uplink and downlink priorities, a third embodiment has been created which, compared to said first and second embodiment, is a little bit more complex, but still of low complexity compared to prior art solutions due to just using said interference detection results (possibly per service) for defining increasing/decreasing priorities, thereby for example preventing that some of the timeslots of the group of timeslots join said first number of timeslots or join said second number of timeslots. This third embodiment keeps interference at a minimum while now taking into account interference detection results (possibly per service). After a timeslot has been selected (based upon uplink or downlink priorities) for being (re)allocated to an uplink or a downlink, generally one or more interference detections will no longer be required for checking interference constraints, due to these interference detections being made beforehand possibly per service), which may speed up the (re)allocation procedure.

A fourth embodiment of the telecommunication system according to the invention is defined by claim 5.

Generally said at least one of said stations comprising the memory will correspond with the base station or the node etc. However, a mobile station comprising this memory is not to be excluded, for example for negotiating with said base station or said node etc., or for example for informing said base station or said node etc., or for example for communicating with another mobile station etc.

A fifth embodiment of the telecommunication system according to the invention is defined by claim 6.

Generally said at least one of said stations comprising the allocator will correspond with the base station or the node etc. However, a mobile station comprising this allocator is not to be excluded, for example for informing said base station or said node etc., or for example for communicating with another mobile station etc. Generally said at least one of said stations comprising the interference detector will correspond with the base station or the node etc. for detecting base-station-mobile-station-interference and base-station-base-station-interference. However, a mobile station comprising this interference detector is not to be excluded for detecting mobile-station-mobile-station-interference and possibly base-station-mobile-station-interference, for example for negotiating with said base station or said node etc., or for example for informing said base station or said node etc., or for example for communicating with another mobile station etc.

Said interference detector for example performs the interference measurements disclosed in EP 1 122 895 A1, which discusses in its paragraph 0020 the measuring of relative signal strengths, of distances, of emitted power, of (required) bit rates etc.

A sixth embodiment of the telecommunication system according to the invention is defined by claim 7.

Generally said at least one of said stations comprising this processor will correspond with the base station or the node etc. However, a mobile station comprising this processor is not to be excluded, for example for negotiating with said base station or said node etc., or for example for informing said base station or said node etc., or for example for communicating with another mobile station etc.

The invention is based upon an insight, inter alia, that some timeslots should be fixed and others should be flexible when creating a more practical system, and is based upon a basic idea, inter alia, that uplink and downlink priorities can be defined for supporting said (re)allocating.

The invention solves the problem, inter alia, of providing a more practical telecommunication system, and is further advantageous, inter alia, in that said uplink priorities and downlink priorities keep interference at a minimum due to selected timeslots from said first number of timeslots and selected timeslots from said second number of timeslots being selected (read: getting their priorities) in accordance with getting minimum interference.

It should be noted that the article “Comparisons of Channel Assignment Strategies in Cellular Mobile Telephone Systems” by Ming Zang and Tak-Shing P. Yum in IEEE Transactions on Vehicular Technology Vol. 38 No. 4 dated November 1989 discloses a first channel of a cell having a maximum local-use priority and a last channel of this cell having a maximum borrowing priority in a channel borrowing environment. Due to said borrowing priorities defining an order in which channels are to be borrowed by neighboring cells, the telecommunication system defined in this article is completely different from the telecommunication system according to the invention. Further, said article does not discuss the difference between uplinks and downlinks, and does not mention any uplink priorities and downlink priorities, and does not disclose that some timeslots should be allocated fixedly to an uplink or a downlink and that others should be (re)allocatable to an uplink or a downlink flexibly.

Embodiments of the station according to the invention, of the method according to the invention and of the processor program product according to the invention correspond with the embodiments of the telecommunication system according to the invention.

These and other aspects of the invention will be apparent from and elucidated with reference to the embodiments(s) described hereinafter.

FIG. 1 illustrates in block diagram form a telecommunication system according to the invention comprising cells,

FIG. 2 illustrates in block diagram form a first station according to the invention,

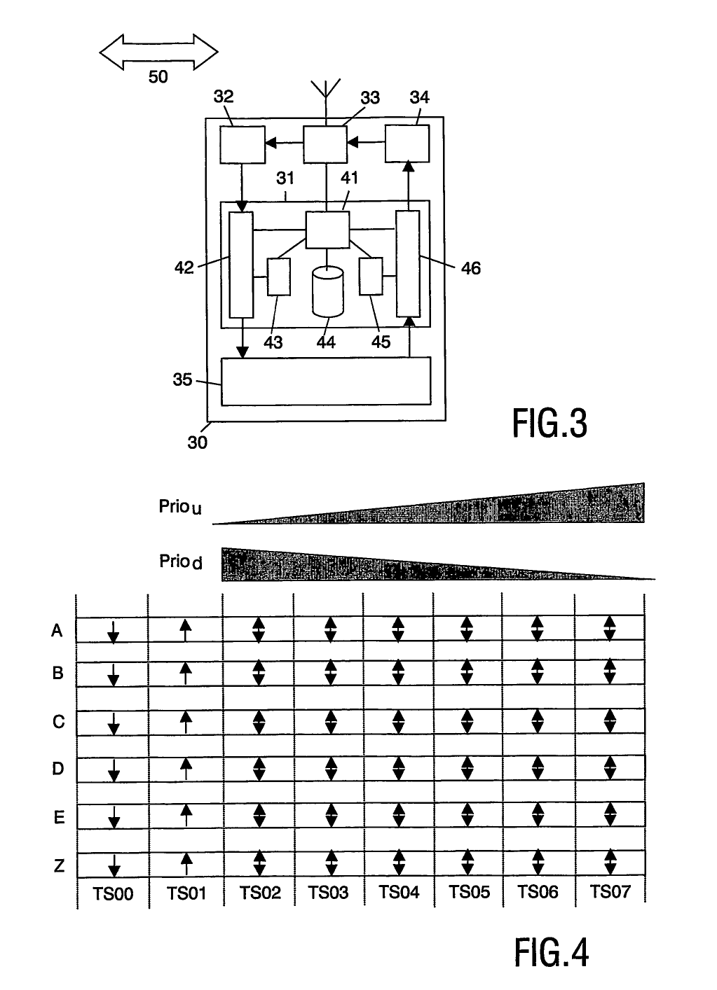

FIG. 3 illustrates in block diagram form a second station according to the invention,

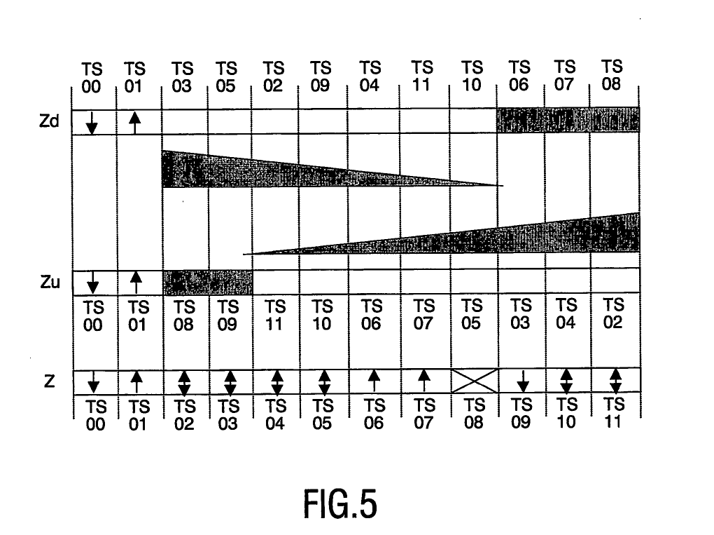

FIG. 4 illustrates a first allocation overview in accordance with the first embodiment of the telecommunication system according to the invention, and

FIG. 5 illustrates a second allocation overview in accordance with the third embodiment of the telecommunication system according to the invention.

The telecommunication system shown in FIG. 1 comprises cells A,B,C,D,E,Z, with Z being a cell surrounded/neighboured by cells A-E. Generally, each cell comprises a first station 10 as shown in FIG. 2 which for example corresponds with a base station or a node etc. Each cell may further comprise one or more second stations 30 as shown in FIG. 3 which for example correspond with a mobile station etc.

The first station 10 shown in FIG. 2 comprises a controller 11, a demodulator 12, a transceiver 13, a modulator 14 and a switch 15. An in/output of transceiver 11 is coupled to an antenna, an output of transceiver 11 is coupled to an input of demodulator 12 and an input of transceiver 11 is coupled to an output of modulator 14. Controller 11 comprises a processor 21 coupled to a further in/output of said transceiver 13 and can communicate with a first interface 22 and an interference detector 23 and a memory 24 and an allocator 25 and a second interface 26. First interface 22 is coupled to an output of demodulator 12 and to an input of switch 15, and can communicate with interference detector 15. Second interface 26 is coupled to an input of modulator 14 and to an output of switch 15, and can communicate with allocator 25. Switch 15 is further coupled to a network.

The second station 30 shown in FIG. 3 comprises a controller 31, a demodulator 32, a transceiver 33, a modulator 34 and a man-machine-interface or mmi 35. An in/output of transceiver 33 is coupled to an antenna, an output of transceiver 31 is coupled to an input of demodulator 32 and an input of transceiver 33 is coupled to an output of modulator 34. Controller 31 comprises a processor 41 coupled to a further in/output of said transceiver 33 and can communicate with a first interface 42 and an interference detector 43 and a memory 44 and an allocator 45 and a second interface 46. First interface 42 is coupled to an output of demodulator 32 and to an input of mmi 35, and can communicate with interference detector 45. Second interface 46 is coupled to an input of modulator 34 and to an output of mmi 35, and can communicate with allocator 45. Mmi 35 for example comprises a display and/or a keyboard and/or a microphone and/or a loudspeaker etc.

First station 10 and second station 30 communicate with each other via communication channel 50, thereby using one or more uplink timeslots and one or more downlink timeslots. In case this communication requires more downlink capacity, for example due to video information needing to be sent down, either an uplink timeslot must be re-allocated to a downlink timeslot, or a timeslot not yet allocated must be allocated to a downlink timeslot. In case a third station enters the cell in which said first station 10 is located and wants to communicate with or via said first station 10, one or more uplink timeslots and one or more downlink timeslots are required. Then these one or more uplink timeslots and one or more downlink timeslots must be allocated, either by allocating one or more timeslots not yet allocated, and/or by re-allocating uplink timeslots and/or downlink timeslots.

Said communication channel 50 has a time-frame structure with at least one group or (sub)frame of timeslots, in which group or (sub)frame at least two timeslots are flexible timeslots each being (re)allocatable to an uplink or a downlink. According to the invention, in said group or (sub)frame at least one timeslot is a fixed uplink timeslot, at least one timeslot is a fixed downlink timeslot, and said at least two flexible timeslots comprise a first number of timeslots having a priority of an uplink kind and a second number of timeslots having a priority of a downlink kind. These flexible priorities are used for selecting the timeslot to be (re)allocated. In case of an extra uplink (downlink) timeslot is required, the timeslot with the priority of an uplink (downlink) kind having the highest value is chosen.

According to a first embodiment of the telecommunication system according to the invention, a first allocation overview as shown in FIG. 4 is used. Said group of timeslots corresponds with a (sub)frame, with said at least one fixed uplink timeslot being one fixed uplink timeslot TS01, with said at least one fixed downlink timeslot being one fixed downlink timeslot TS00, and with said at least two flexible timeslots corresponding with all other timeslots TS02-TS07 in said (sub)frame and this time being equal to said first number of (subsequent) timeslots TS02-TS07 and to said second number of (subsequent) timeslots TS02-TS07. Said first number of (subsequent) timeslots TS02-TS07 have a priority of an uplink kind or in other words an uplink priority (increasing) as shown in FIG. 4 by Prioᵤ. Timeslot TS02 has an uplink priority with for example a value 1, timeslot TS03 has an uplink priority with for example a value 2, etc., with timeslot TS07 having an uplink priority with for example a value 6. Said second number of (subsequent) timeslots TS02-TS07 have a priority of an downlink kind or in other words a downlink priority (decreasing) as shown in FIG. 4 by Prio_{d}. Timeslot TS02 has a downlink priority with for example a value 6, timeslot TS03 has a downlink priority with for example a value 5, etc., with timeslot TS07 having a downlink priority with for example a value 1.

This first embodiment is low complex, due to said first number of (subsequent) timeslots and said second number of (subsequent) timeslots coinciding. After a timeslot has been selected (based upon uplink or downlink priorities) for being (re)allocated to an uplink or a downlink, generally one or more interference detections will be required for checking interference constraints, possibly per service.

According to a second embodiment of the telecommunication system according to the invention, rules are used for defining locations for said first number and said second number of timeslots, thereby taking into account neighboring cells. Said group of timeslots corresponds with a (sub)frame of a cell, with one timeslot of said first number of timeslots being located at one end of said at least two flexible timeslots and having a maximum priority of an uplink kind and with further timeslots of said first number of timeslots having lower (decreasing when looking from this one end, increasing when looking from the other end) priorities of an uplink kind, and with one timeslot of said second number of timeslots being located at the other end of said at least two flexible timeslots and having a maximum priority of a downlink kind and with further timeslots of said second number of timeslots having lower (decreasing when looking from this other end, increasing when looking from the one end) priorities of a downlink kind.

Suppose timeslot TS0 is a fixed downlink timeslot, timeslot TS1 is a fixed uplink timeslot, and timeslots TS2-TSN are flexible timeslots. Said rules (without excluding other rules) are for example as follows:
1) Downlink channels will be assigned one by one beginning at timeslot TS2.
2) Downlink channels will be assigned one by one beginning at timeslot TSN.
3) As to a given cell, for example Z in FIG. 1, the downlink timeslot channel number (from TS2 to TSN) N_{d} is determined by the formulae
   N_{d}=min {max [N_{d,i}^{adj}(Z)], max [N−N_{u,i}^{adj}(Z)−1]}
   where i ε {A,B,C,D,E}, with N_{d,i}^{adj}(Z) being the used downlink timeslot channel number (from TS2 to TSN) of adjacent cell i, and with N_{u,i}^{adj}(Z) being the used uplink timeslot channel number (from TS2 to TSN) of adjacent cell i.
4) As to a given cell, for example Z in FIG. 1, the uplink timeslot channel number (from TS2 to TSN) Nᵤ is determined by the formulae
   Nᵤ=min {max [N_{u,i}^{adj}(Z)], max [N−N_{d,i}^{adj}(Z)−1]}
   where i ε{A,B,C,D,E}, with N_{d,i}^{adj}(Z) being the used downlink timeslot channel number (from TS2 to TSN) of adjacent cell i, and with N_{u,i}^{adj}(Z) being the used uplink timeslot channel number (from TS2 to TSN) of adjacent cell i.
5) The optional channel number Nₒ (uplink or downlink) is determined by
   Nₒ=max (0, N−N_{d}−Nᵤ)
6) Then timeslots TS2 to TSK are to be used as downlink timeslots, and TSL to TSN are to be used as uplink timeslots, with K=N_{d}+1 and L=N−Nᵤ+1.

By using said rules for defining per (sub)frame that said first number of (subsequent) timeslots TSL to TSN is situated at one side of said group of timeslots and that said second number of (subsequent) timeslots TS2 to TSK is situated at the other side of said group of timeslots, a second embodiment has been created which, compared to said first embodiment, is a little bit more complex, but still of low complexity, and which keeps interference at a minimum while now taking into account neighboring cells. After a timeslot has been selected (based upon uplink or downlink priorities) for being (re)allocated to an uplink or a downlink, generally one or more interference detections will be required for checking interference constraints, possibly per service.

According to a third embodiment of the telecommunication system according to the invention, a second allocation overview as shown in FIG. 5 is used, and uplink and downlink priorities are defined by interference detection results. Said group of timeslots corresponds with a (sub)frame, with said at least one fixed uplink timeslot being one fixed uplink timeslot TS0, with said at least one fixed downlink timeslot being one fixed downlink timeslot TS00, and with said at least two flexible timeslots corresponding with all other timeslots TS02-TS11 in said (sub)frame. Said first number of (generally non-subsequent) timeslots TS11, TS10, TS06, TS07, TS05, TS03, TS04 and TS02 have a priority of an uplink kind or in other words an uplink priority (increasing) as shown in FIG. 5 (Zᵤ). Timeslot TS11 has an uplink priority with for example a value 1, timeslot TS10 has an uplink priority with for example a value 2, etc., with timeslot TS02 having an uplink priority with for example a value 8. Timeslots TS08 and TS09 are blocked for uplink allocations. Said second number of (generally non-subsequent) timeslots TS03, TS05, TS02, TS09, TS04, TS11 and TS10 have a priority of an downlink kind or in other words a downlink priority (decreasing) as shown in FIG. 5 (Z_{d}). Timeslot TS03 has a downlink priority with for example a value 7, timeslot TS05 has a downlink priority with for example a value 6, etc., with timeslot TS10 having a downlink priority with for example a value 1. Timeslots TS06, TS07 and TS08 are blocked for downlink allocations.

As a result, as shown in FIG. 5 (Z), timeslot TS00 is a fixed downlink timeslot, timeslot TS01 is a fixed uplink timeslot, TS02 to TS05 are optional (flexible) timeslots, TS06 and TS07 are uplink (flexible) timeslots which however for example at the moment due to interference cannot be re-allocated to downlinks, timeslot TS08 is a (flexible) timeslot which however for example at the moment due to interference cannot be re-allocated to whatever link, TS09 is a downlink (flexible) timeslot which however for example at the moment due to interference cannot be re-allocated to an uplink, and TS10 and TS11 are optional (flexible) timeslots. The optional (flexible) timeslots TS02 to TS05 and TS10 and TS11 can be allocated to uplinks (downlinks) in dependence of their uplink (downlink) priorities.

By using interference detection results (possibly per service) for defining uplink and downlink priorities, a third embodiment has been created which, compared to said first and second embodiment, is a little bit more complex, but still of low complexity compared to prior art solutions due to just using said interference detection results (possibly per service) for defining said increasing and decreasing priorities, thereby for example preventing that some of the timeslots of the group of timeslots join said first number of timeslots or join said second number of timeslots. This third embodiment keeps interference at a minimum while now taking into account interference detection results (possibly per service). After a timeslot has been selected (based upon uplink or downlink priorities) for being (re)allocated to an uplink or a downlink, generally one or more interference detections will no longer be required for checking interference constraints, due to these interference detections being made beforehand (possibly per service), which may speed up the (re)allocation procedure.

The invention is based upon an insight, inter alia, that some timeslots should be fixed and others should be flexible when creating a more practical system, and is based upon a basic idea, inter alia, that uplink and downlink priorities can be defined for supporting said (re)allocating.

The invention solves the problem, inter alia, of providing a more practical telecommunication system, and is advantageous, inter alia, in that said uplink priorities and downlink priorities keep interference at a minimum due to selected timeslots from said first number of timeslots and selected timeslots from said second number of timeslots being selected in accordance with getting minimum interference (by staying away from each other as far as possible and/or as long as possible and/or by using interference detection results).

In station 10 (30) as shown in FIG. 2 (3), controller 11 (31) comprises the parts processor 21 (41), interfaces 22,26 (42,46), interference detector 23 (43), memory 24 (44) and allocator 25 (45). Each part may be 100% hardware, 100% software or a mixture of both. In case of interfaces 22,26 (42,46), interference detector 23 (43), memory 24 (44) and/or allocator 25 (45) being at least partly software, these parts can run via processor 21 (41). In case of processor 21 (41) being at least partly software, the parts can run via controller 11 (31) in the form of for example a processor.

The expression “for” in for example “for transmitting” and “for receiving” does not exclude that other functions are performed as well, simultaneously or not. The expressions “X coupled to Y” and “a coupling between X and Y” and “coupling/couples X and Y” etc. do not exclude that an element Z is in between X and Y. The expressions “P comprises Q” and “P comprising Q” etc. do not exclude that an element R is comprises/included as well. The terms “a” and “an” do not exclude the possible presence of one or more pluralities.

Although the first embodiment shown in FIG. 4 discloses eight timeslots per subframe and the third embodiment shown in FIG. 5 discloses twelve timeslots per subframe, the invention is not limited to these (sub)frame-sizes. For example in a 1.28M TDD system, there are seven timeslots per subframe, and in a 3.84M TDD system, there are fifteen timeslots per subframe (3GPP WCDMA), and other (sub)frame-sizes are not to be excluded.

1. Telecommunication system comprising at least a first station and a second station for providing a telecommunication service via at least one communication channel with a time-frame structure with at least one group of timeslots, in which group at least two timeslots are flexible timeslots each being (re)allocatable to an uplink or a downlink, wherein in said group at least one timeslot is a fixed uplink timeslot, at least one timeslot is a fixed downlink timeslot, and said at least two flexible timeslots comprise a first number of timeslots having a priority of an uplink kind and a second number of timeslots having a priority of a downlink kind.

2. Telecommunication system according to claim 1, wherein said group of timeslots corresponds with a (sub)frame, with said at least one fixed uplink timeslot being one fixed uplink timeslot, with said at least one fixed downlink timeslot being one fixed downlink timeslot, and with said at least two flexible timeslots corresponding with all other timeslots in said (sub)frame and being equal to said first number of timeslots and to said second number of timeslots, with one kind of priority increasing and with the other kind of priority decreasing per timeslot.

3. Telecommunication system according to claim 1, wherein said group of timeslots corresponds with a (sub)frame of a cell, with one timeslot of said first number of timeslots being located at one end of said at least two flexible timeslots and having a maximum priority of an uplink kind and with further timeslots of said first number of timeslots having decreasing priorities of an uplink kind, and with one timeslot of said second number of timeslots being located at the other end of said at least two flexible timeslots and having a maximum priority of a downlink kind and with further timeslots of said second number of timeslots having decreasing priorities of a downlink kind, and with said first number of timeslots and said second number of timeslots being defined by rules which take into account at least one adjacent cell.

4. Telecommunication system according to claim 1, wherein at least said first number of timeslots having a priority of an uplink kind and said second number of timeslots having a priority of a downlink kind are defined by interference detection results.

5. Telecommunication system according to claim 1, wherein at least one of said stations comprises a memory for storing priority parameters, with said first number of timeslots being defined by priority parameters of an uplink kind and with said second number of timeslots being defined by priority parameters of a downlink kind.

6. Telecommunication system according to claim 5, wherein at least one of said stations comprises an allocator for, upon request for uplink/downlink capacity, allocating at least one flexible timeslot to an uplink/downlink, in dependence of uplink/downlink priority parameters, with at least one of said stations comprising an interference detector for generating interference detection results.

7. Telecommunication system according to claim 6, wherein at least one of said stations comprises a processor for defining said first number of timeslots and said second number of timeslots at the hand of rules which take into account at least one adjacent cell.

8. Station for use in a telecommunication system comprising at least a first station and a second station for providing a telecommunication service via at least one communication channel with a time-frame structure with at least one group of timeslots, in which group at least two timeslots are flexible timeslots each being (re)allocatable to an uplink or a downlink, wherein in said group at least one timeslot is a fixed uplink timeslot, at least one timeslot is a fixed downlink timeslot, and said at least two flexible timeslots comprise a first number of timeslots having a priority of an uplink kind and a second number of timeslots having a priority of a downlink kind, with said station comprising a memory for storing priority parameters, with said first number of timeslots being defined by priority parameters of an uplink kind and with said second number of timeslots being defined by priority parameters of a downlink kind.

9. Method for use in a telecommunication system comprising at least a first station and a second station for providing a telecommunication service via at least one communication channel with a time-frame structure with at least one group of timeslots, in which group at least two timeslots are flexible timeslots each being (re)allocatable to an uplink or a downlink, wherein in said group at least one timeslot is a fixed uplink timeslot, at least one timeslot is a fixed downlink timeslot, and said at least two flexible timeslots comprise a first number of timeslots having a priority of an uplink kind and a second number of timeslots having a priority of a downlink kind, which method comprises the step of allocating, upon request for uplink/downlink capacity, at least one flexible timeslot to an uplink/downlink, in dependence of uplink/downlink priority parameters.

10. Processor program product to be run via a processor in a station in a telecommunication system comprising at least a first station and a second station for providing a telecommunication service via at least one communication channel with a time-frame structure with at least one group of timeslots, in which group at least two timeslots are flexible timeslots each being (re)allocatable to an uplink or a downlink, wherein in said group at least one timeslot is a fixed uplink timeslot, at least one timeslot is a fixed downlink timeslot, and said at least two flexible timeslots comprise a first number of timeslots having a priority of an uplink kind and a second number of timeslots having a priority of a downlink kind, which processor program product comprises the function of processing priority parameters via a memory, with said first number of timeslots being defined by priority parameters of an uplink kind and with said second number of timeslots being defined by priority parameters of a downlink kind.
